(19) United States
(12) Patent Application Publication
(10) Pub. No.: US 2014/0080088 A1
(43) Pub. Date: Mar. 20, 2014

(54) DENTAL ARTICULATOR

(71) Applicant: Yun soon Kim, Duluth, GA (US)

(72) Inventor: Yun soon Kim, Duluth, GA (US)

(73) Assignees: DENTSOLL KOREA CO., LTD., Jangseong-Gun (KR); Yun soon KIM, Duluth, GA (US)

(21) Appl. No.: 13/203,904

(22) PCT Filed: Jun. 20, 2011
(86) PCT No.: PCT/KR2011/004483

§ 371 Date: Aug. 30, 2011

(30) Foreign Application Priority Data
Jun. 9, 2011 (KR) 10-2011-0055723

(51) Int. Cl. A61C 11/08; A61C 11/02

(52) U.S. Cl. CPC A61C 11/08; A61C 11/02
USPC 433/57; 433/60

(57) ABSTRACT

Provided is a dental articulator, and more particularly, a dental articulator, in which a tray keeping a shape and dimensions of a dental model is fitted into an upper portion of a base member to which the dental model is coupled. Particularly, the tray coupled to a top surface of the base member is geometrically similar to the base member, and includes a boundary wall formed along an edge thereof at a predetermined thickness and height, a through-hole formed inside the boundary wall, and a pin cap structure that has a plurality of fitting holes into which pins of a pin structure of the base member are fitted and which are continuously formed along an inner central axis of the through-hole and that is connected to opposite inner ends of the boundary wall. Further, each of the arcuate and linear boundary walls of the tray has a plaster anti-overflow flange formed at an upper end thereof and bent in an outward direction to prevent plaster from overflowing down. The front arcuate boundary wall includes tool insertion cages in lower ends of both lateral surfaces thereof which are recessed inwards so that the dental model is easily separated from the base member after being hardened.

### BACKGROUND OF THE INVENTION

1. Field of the Invention

The present invention relates, in general, to a dental articulator, and, more particularly, to a dental articulator, in which a tray keeping a shape and dimensions of a dental model is fitted into the upper portion of a base member to which the dental model is coupled, thereby firmly fixing the dental model and a die as well as facilitating occlusion and separation.

2. Description of the Related Art

Generally, dental articulators are dental instruments that are intended to provide reliable dental prostheses such as dentures and crowns by realizing a dental structure and temporomandibular movement of a patient to check a maxillomandibular structure, occlusion and mastication in order to obtain the dental prostheses optimized to the dental structure of the patient at dental clinics and laboratories.

These dental articulators are divided into partial types (quadrant and anterior) and full-arch types according to a dental model of a patient whose teeth need to be treated, and are fabricated and used as such. The dental articulators have been made of metal so as to be used in a firm and semi-permanent way. The metal articulators are each designed so that maxillary and mandibular articulators are coupled to each other. For this reason, the metal articulators have low workability, heavy weight, difficult operation and usage, and expensive cost. To overcome drawbacks of the metal articulators, disposable articulators formed of plastic have recently been used widely.

Such disposable plastic articulators are configured so that pin holes, into which pins can be inserted, are typically formed in the top surface of a base member acting as a basic mold, or so that a pin structure integrally protrudes from the base member in order to reduce inconvenience of inserting the pins that have been made separately.

A dental cast for a patient, which has been molded of dental plaster using a dental impression, is placed and hardened on the top surface of the base member, so that a dental model for the patient is molded.

When the dental model is molded on the base member, the dental plaster flows down an outer circumferential surface of the base member. Thus, a process of grinding the plaster flowing down the outer circumferential surface of the base member to clean the outer circumferential surface of the base member after the dental model is molded, and then a process of sawing the dental model, a part of which corresponds to teeth to be treated and is integrally molded with other adjacent dental models, are performed. Then, the subsequent dental laboratory work is performed.

However, the grinding process is performed on lateral surfaces of the base member having a predetermined height using a grinder. In this case, if the lateral surfaces of the base member are flat, a rotating blade of the grinder which rotates at high speed is difficult to eliminate only the plaster that flows down the outer circumferential surface of the base member and protrudes from the outer circumferential surface of the base member. Furthermore, when the protruding plaster is eliminated, the rotating blade of the grinder comes into contact with the outer circumferential surface of the base member, so that grinding efficiency is reduced.

After the process of eliminating the plaster around the base member in this way is completed, a process of checking an occlusal relationship between the maxillary articulator and the mandibular articulator is performed, thereby checking whether or not the dental model of the patient is correctly molded, whether or not occlusal surfaces of the maxillary articulator and the mandibular articulator are correctly matched with each other, and whether or not interference between adjacent teeth occurs.

Further, since the dental model of the patient includes teeth to be treated as well as their adjacent teeth integrally formed with the teeth to be treated, a process of cutting off a part of the dental model which corresponds to the teeth to be treated by sawing is preformed.

In this case, the partial dental model (hereinafter, referred to as a “die”), which is isolated from the adjacent dental model by the sawing and is used for treatment, is not easily separated from the base member even by the process of cutting off a part of the dental model by the sawing, because a pin structure that is integrally formed with and protrudes from the base member is embedded and fixed in a bottom surface thereof.

Thus, to separate the die isolated from the adjacent dental model from the base member, a process of applying a release agent such as silicon between the bottom surface of the die and the top surface of the base member, a process of seeking for a separable gap, a process of inserting a pointed tool into the gap, and a process of separating the bottom surface of the die from the top surface of the base member to which the bottom surface of the die is adhered are performed.

In this case, when a worker applies an excessive force to the die, the die is broken or damaged. Since the worker should separate the die with strong, but not excessive, force, the worker feels higher fatigue, and suffers from low working efficiency.

Further, the dental laboratory work is performed on the die which is cut off from the dental model of the patient whose teeth are to be treated and which is separated from the base member. In detail, to check the occlusal relationship between the maxillary articulator and the mandibular articulator, a space between adjacent teeth, and so forth, a process of putting the separated die into and out of the pin structure of the base member is repeated as needed.

In this manner, while the process of putting the cut dental model, i.e. the die, into and out of the pin structure of the base member is repeated, the die clamped by a part of the pin structure undergoes left-and-right movement because of gaps generated on the opposite ends thereof by the sawing.

However, the dental model for a patient should be processed with very high precision. Thereby, the dental prosthesis provided to the patient ensures high quality, and causes no inconvenience during the mastication between the maxilla and the mandible to ingest foods after the prosthodontic treatment.

Thus, in the dental laboratory work, it is above all important for the die separated from the base member to be kept in its place without arbitrary movement on the top surface of the base member after the die is repetitively decoupled and coupled. The conventional dental articulators fixing the separated die using one independent pin structure and their structures have limitations in stably fixing the separated die.

Particularly, when the teeth of a patient for the dental treatment are located at the maxilla, the die cut off from the entire dental model easily comes out of the pin structure of the dental articulator although it is fitted in its place. As such, when the die disconnected from the adjacent dental model is processed, a worker should catch the die with hand, so that the workability is reduced.

Further, in the case of the plastic dental articulators that are fabricated and distributed for disposables, a plurality of support members are formed at one end of the base member for the maxillomandibular occlusion. Each support member protrudes outwardly from the base member at a predetermined length. The closer an angle between the support member and the base member becomes to a right angle, the higher the strength of the support member supporting the base member becomes. However, the plaster molding process of the dental model performed on the top surface of the base member becomes more inconvenient.

In contrast, as the angle between the support member and the base member increases, the plaster molding process of the dental model performed on the top surface of the base member becomes more convenient. However, the support member is apt to be bent or deformed due to weight of the plaster placed on the top surface of the base member, so that it is difficult to accurately realize the temporomandibular joint of a patient. To avoid this problem, the strength of the support member should be increased. To increase the strength, the weight of the support member has nothing but to be increased.

Further, in the dental articulators having the maxillomandibular structure, when it is necessary to separate the maxillary articulator and the mandibular articulator from each other, this separation should be performed by decoupling connectors formed at respective leading ends of the support members. To this end, a worker catches the support members formed on the maxillary and mandibular articulators that are steadily fabricated to increase the strength with hand, and then decouples the connectors. However, the worker has difficulty in decoupling the connectors.

In the conventional dental articulators, the pin structure protruding from the top surface of the base member has the same interval between the pins. This structure does not reflect the real dental structure of a human body in which the anterior teeth (incisors) and the posterior teeth (molars) have different in size or interdental space. As such, the pin structure protruding from the top surface of the base member is cut in the sawing or cutting process. It is difficult to separate a cut dental structure. When the separated die is again coupled to the base member, the pin structure clamping the die is cut, and thus the die is not firmly clamped.

Further, after one or more dies are separated from the dental model molded on the top surface of the base member, a worker may make a mistake in finding a position of the separated die and mount the die at a wrong position. In this case, the worker must make another effort to mount the separated die at a correct position.

### SUMMARY OF THE INVENTION

Accordingly, the present invention has been made keeping in mind the above problems occurring in the related art, and an objective of the present invention is to provide a dental articulator capable of providing an easy process and a short time of grinding a dental model after the dental model is molded, an aesthetic geometry, and cost saving by modifying the shape and structure of a base member on which the dental model is placed.

Another objective of the present invention is to provide a dental articulator capable of easily separating a die from the base member when dental laboratory work is performed, effectively preventing the die from moving arbitrarily in the process of decoupling and coupling the die, preventing the die coupled to the base member from being separated spontaneously by self-weight during maxillary working so as to improve the convenience of work, and providing a high-quality dental prosthesis.

Another objective of the present invention is to provide a dental articulator, which provides proper installation and structure of support members coupled to the base member, capable of providing easiness of a plaster molding process and the subsequent process, and easily separating maxillary and mandibular support members from each other.

Another objective of the present invention is to provide a dental articulator, which allows the die separated from the entire dental model on a top surface of the base member to be accurately put in its place again, and thus allows the dental laboratory work to be easily performed.

In order to achieve the above objective, according to one aspect of the present invention, there is provided a dental articulator, which comprises: a base member on a top surface of which a dental model is molded; a pair of support members that are formed at one end of the base member so as to have a predetermined height in an upward direction and a predetermined slope in an outward direction; a pair of connectors that are formed at upper ends of the pair of support members so as to be coupled with a counter dental articulator; a pin structure that is integrally formed with the base member at a predetermined height and that has a plurality of pins protruding upwardly from the top surface of the base member along a central axis of the top surface of the base member in a row at predetermined intervals; and a tray that is coupled to the top surface of the base member, that includes a through-hole therein and a boundary wall formed along an edge thereof at a predetermined thickness and height, and that is geometrically similar to the base member.

Here, the plurality of pins of the pin structure may be continuously connected to one another at a predetermined height from lower ends thereof; and the tray may include a pin cap structure having a plurality of fitting holes into which the pins of the pin structure are fitted and which are continuously formed inside the boundary wall along a central axis of the tray at predetermined intervals.

Further, the pin cap structure may have a lower height than the pin structure, so that, when the pin cap structure is coupled to the pin structure, the pins of the pin structure are partially exposed out of the fitting holes of the pin cap structure; and the pin cap structure may include: through-holes that are formed in an edge thereof at predetermined intervals; and hemispherical plaster injection ports that are formed on the through-holes and have a larger diameter than the through-holes.

Also, each of the pin structure and the pin cap structure may be configured so that an upper portion thereof accounting for a part of the entire height thereof functions as a taper part whose horizontal cross-sectional area is gradually increased from the top to the bottom, and so that a lower portion thereof located under the taper part functions as a linear part whose horizontal cross-sectional area is equal to that of the lowermost end of the taper part.

Further, the tray placed on the top surface of the base member may be configured so that an inner surface of the boundary wall thereof is flush with an outer surface of the base member or slightly protrudes outwardly beyond the outer surface of the base member.

Meanwhile, the base member may include a fixture piece protruding from a front outer surface thereof at a predetermined length, and the tray may include an insertion piece formed on a front bottom surface thereof so as to correspond to the fixture piece and fitted around the fixture piece. Thereby, the tray can be firmly supported on the top surface of the base member without swinging or rocking. The front arcuate (or U-shaped) boundary wall of the tray may include hooks that extend from rear lower ends of both lateral surfaces thereof to a predetermined height and are pushed onto rear lateral surfaces of the base member so as to constrict left and right movement of the tray; and the rear linear boundary wall of the tray may include a movement stopper that extends from a lower end thereof to a predetermined height and is pushed onto a rear outer surface of the base member so as to constrict the movement of the tray.

Further, each boundary wall of the tray may include a plaster anti-overflow flange that is formed at an upper end thereof at a predetermined width and that is bent in an outward direction to prevent plaster from overflowing down; and the front arcuate (or U-shaped) boundary wall of the tray may include a plurality of tool insertion cages in lower ends of both lateral surfaces thereof which are recessed inwards by a predetermined depth at predetermined intervals. Thereby, after the dental model is molded, the dental model can be easily separated.

Also, the front arcuate (or U-shaped) boundary wall of the tray may include round grooves formed in an inner circumferential surface thereof at regular intervals. Thus, round protrusions are formed on an outer surface of the dental model molded inside the front arcuate boundary wall of the tray, so that it is possible to increase a catching force of a worker when dental laboratory work is performed.

Further, the base member may include pressurization holes formed in a bottom surface thereof so that, when another tray is coupled to another base member for another dental articulator, the base member is fitted onto another pin cap structure coupled to another pin structure and pressurizes the other pin cap structure. Thereby, it is possible to prevent a space from being formed between the bottom surface of the pin cap structure and the top surface of the base member to the utmost after the tray is coupled to the top surface of the base member.

Further, to easily find a position of the die separated after the dental model is molded, the base member may have serial numbers that are formed in relief on the top surface thereof on one side of the pin structure formed on the top surface of the base member and that represent a sequence of the pins of the pin structure.

The pin cap structure formed inside the tray may have tearaway notches formed in top surfaces of opposite joints thereof which are connected with the inner surface of the front and rear boundary walls so as to be easily separated from the boundary wall. Thereby, after the dental model is molded, the boundary walls can be easily removed.

Further, the pair of support members may be formed in parallel on a top surface of a flat joint plate, which is coupled to a rear surface of the base member at a predetermined size, so as to be inclined at a predetermined angle; and the pair of support members may be configured so that an interval therebetween is gradually increased from lower ends thereof coupled to the joint plate to upper ends thereof. Thereby, the dental articulator having the plaster dental model can be maintained in a firm posture.

Also, the connectors formed at the left and right upper ends of the support members may include a pivot piece having a male structure and a clamp piece having a female structure, respectively; and one of the pivot piece and the clamp piece may include a primary stopper formed in the front thereof in a cylindrical shape at a predetermined height, so that, when the dental articulator and the counter dental articulator for a maxilla and a mandible are coupled and occluded, the primary stopper prevents the maxillary and mandibular dental articulators from being folded beyond an optimum angle. In addition to the primary stopper, the joint plate may further include an auxiliary stopper formed on one side of a rear end thereof at a height enough to come into contact with the surface of the joint plate of the counter dental articulator, so that, when the pair of dental articulators are coupled to each other by the connectors and are occluded along with the dental models, the auxiliary stopper prevents the maxillary and mandibular dental articulators from being folded beyond the optimum angle.

In addition, each of the primary and auxiliary stoppers may be rounded at an upper end thereof so as to be able to slip on its contact surface to some extent, and include a removal notch in an outer circumferential surface of a lower end thereof so as to enable a worker to push and easily break it when the maxillary and mandibular dental articulators are occluded beyond an optimum angle as needed.

A grinding process is required to eliminate the plaster flowing down or leaking out of the outer surfaces of the base member and the tray when the dental model is molded on the top surface of the base member. In the case of the dental articulator of the present invention, each of the base member and the tray has a tapered outer surface in such a manner that a cross-sectional width thereof is reduced from the top surface to the bottom surface thereof, and the plaster anti-overflow flange is formed at the upper end of the boundary wall of the tray, so that the number of processes of grinding the surface of the plaster flowing down after the plaster molding can be reduced to improve the efficiency of the dental laboratory work.

Further, the numerous pins of the pin structure for fixing the dental model are continuously formed at the lower ends thereof by the tie having a predetermined height, so that, when the dental model and the die are separated, or when the separated die is demounted or mounted, the pin structure prevents swinging or rotation of the die. As a result, precise dental laboratory work is possible, and a reliable dental prosthesis can be provided.

Further, when the dental model is molded and hardened in the tray, the front and rear boundary walls of the tray can be easily removed. A plurality of tool insertion cages are formed in the outer surface of the front boundary wall of the tray, so that the insertion of a tool is made easy when the dental model is separated from the base member, and so that the inconvenience of a worker separating the die with excessive force is reduced. Thereby, the control of the plaster dental model is convenient.

In addition, the primary stopper is formed on the upper end of the support member, and the auxiliary stopper is formed on the top surface of the joint plate. These stoppers prevent the maxillary and mandibular articulators from being excessively occluded beyond a predetermined angle when the maxillary and mandibular articulators are occluded. When the maxillary and mandibular articulators are folded beyond a proper occlusal angle depending on the conditions of a patient, the stoppers can be simply eliminated, so that the occlusal relationship of the dental model of the patient can be checked at various occlusal angles depending on the conditions of the patient and results of molding the dental model.

Further, the upper ends of the primary and auxiliary stopper are rounded. Thus, when a torsion angle should be given to the connector depending on the arrangement of teeth of the patient after the maxillary and mandibular articulators are folded at an occlusal angle, the rounded upper ends of the stoppers slid on the corresponding flat surfaces to permit eccentric occlusion.

A hinge part of the connector formed at a leading end of the support member protrudes outwardly beyond the support member, thereby facilitating extraction from a metal mold when a product is produced by the metal mold. In the hinge part having a male or female structure, a clamp piece having the female structure is provided with a slit in an inner circumference thereof. Thus, when a pivot piece of a counter dental articulator is connected to the clamp piece, the clamp piece elastically moves to provide convenient manipulation.

Further, the pin structure is configured so that an interval between the pins thereof is bit by bit increased from the front to the rear thereof. Serial numbers are formed in relief on one side of the pin structure, and thus are carved in intaglio in the bottom surface of the dental model. Thereby, during the dental laboratory work, it is easy to couple a plurality of dies separated from the entire dental model in their places, and it is possible to prevent the serial numbers from being broken to cause inconvenience by contact with another object because the serial numbers are carved in intaglio.

The pin structure protruding from the base member is exposed to the outside through the fitting holes of the tray. A space other than a fitting installation part having the fitting holes is open to form a through-hole. Thus, the dental plaster molded in the tray comes into direct contact with the base member and the pin structure, so that it is possible to induce precise molding of the dental model.

The pressurization holes, into which the pins of the pin structure formed on the top surface of the base member can be fitted to a predetermined depth, are formed in the bottom surface of the base member. During the dental laboratory work, the bottom surface of another dental articulator is placed and pressurized on the top surface of the dental articulator for the dental laboratory work. In this case, the pin cap structure coupled to the pin structure is pressurized, and thus comes into close contact with the top surface of the base member without being swollen. Thereby, it is possible to precisely mold the dental model.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a disassembled perspective view showing a dental articulator according to an embodiment of the present invention along with a partial enlarged view;

FIG. 2 is a top-down view showing a tray of the inventive dental articulator according to the embodiment of the present invention along with a partial enlarged view;

FIG. 3 is an assembled perspective view showing the dental articulator according to the embodiment of the present invention;

FIG. 4 is a cross-sectional view taken along line A-A of FIG. 3;

FIG. 5 is a cross-sectional view taken along line B-B of FIG. 3;

FIG. 6 is a front view showing the dental articulator according to the embodiment of the present invention;

FIG. 7 is a side view showing the dental articulator according to the embodiment of the present invention;

FIG. 8 is an assembled perspective view of the dental articulator according to the embodiment of the present invention when viewed from the bottom;

FIG. 9 shows the state where a boundary wall of the tray is separated after the dental model is molded by the articulator according to the embodiment of the present invention;

FIG. 10 shows the state where the tray is separated and then the die is separated after the dental model is molded by the articulator according to the embodiment of the present invention; and

FIGS. 11 and 12 are perspective and top-down views showing a dental articulator according to another embodiment of the present invention, respectively.

### DETAILED DESCRIPTION OF THE INVENTION

Reference will now be made in greater detail to an exemplary embodiment of the invention with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the detailed description of the invention, among various types of dental articulators, a quadrant dental articulator used to mold a partial dental model (also called a die) is mainly described. The configuration of the quadrant dental articulator is equally applied to another type of dental articulator, i.e. an anterior dental articulator or a full-arch dental articulator. The other type of dental articulator is schematically shown only in a perspective view.

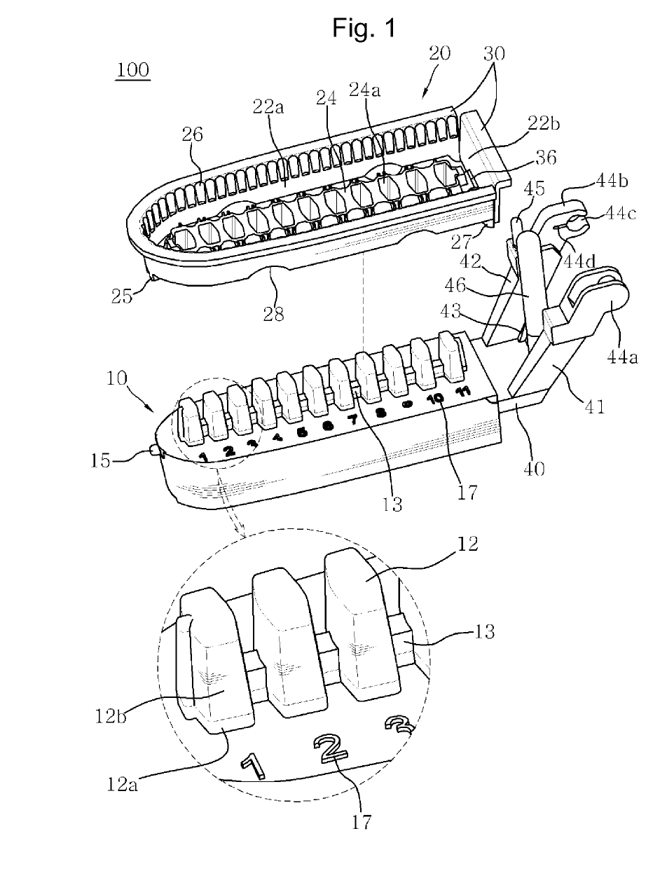

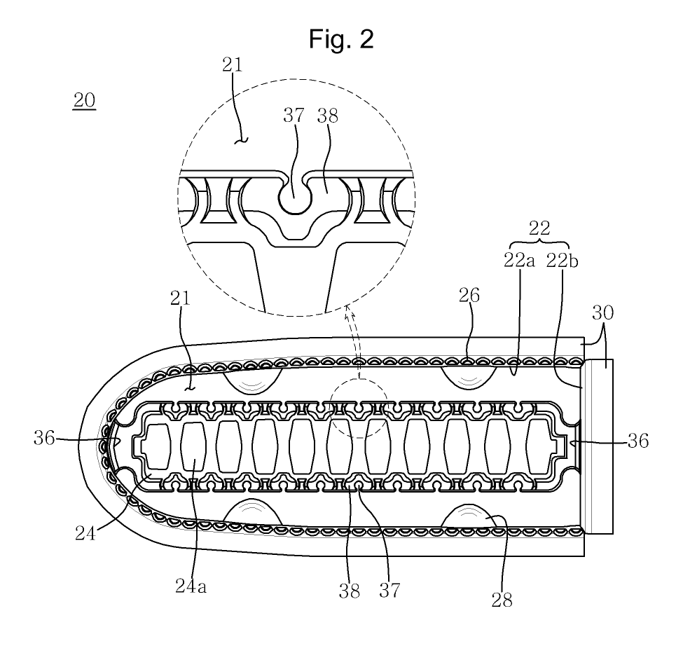

FIG. 1 is a disassembled perspective view showing a dental articulator 100 according to an embodiment of the present invention along with a partial enlarged view. FIG. 2 is a top plan view showing a tray 20 of the inventive dental articulator 100 along with a partial enlarged view.

As shown, the principal feature of the inventive dental articulator 100 is that a basic mold, in which a pre-molded dental cast is placed and hardened in order to mold a dental model, is configured of independent separate members, a base member 10 and a tray 20.

In detail, the base member 10 as one of the characteristic components functions as a basic platform of the dental articulator, and is provided with an in-line pin structure 12 on the central axis of a top surface thereof at a predetermined height according to a shape thereof. The tray 20 as the other characteristic component is placed on the top surface of the base member 10, and determines a shape and size of the dental model.

To mold the dental model of a patient at a dental clinic and laboratory, it is common to fabricate a quadrant or anterior dental articulator (shown as the embodiment of the present invention) in which the dental model is molded for only some of the teeth of the patient which are to be treated, or a full-arch dental articulator in which the dental model is molded for all the teeth of the patient.

The embodiment of the present invention will be described regarding the quadrant dental articulator in which the dental model is molded for some of the teeth. It will be apparent that the technical spirit of the present invention can be applied to the anterior or full-arch dental articulator.

First, the base member 10 constituting a basic framework of the dental articulator 100 will be described.

Since the base member 10 is based on the quadrant dental articulator as described above, it has an arcuate shape (or a U shape) in such a manner that its front surface is rounded and that its rear surface is cut in a vertical direction. Lateral surfaces of the base member 10 are tapered so as to have a slope inclined to an inner side of the base member 10 from the top to the bottom. As a result, after the plaster molding work, a process of grinding the plaster dental model which is molded and hardened on the top surface of the base member 10 is made easy. The base member 100 is provided with a flat joint plate 40 on the rear surface thereof. A pair of support members 41 and 42 are installed on a top surface of the joint plate 40.

The pin structure 12 having a predetermined height protrudes from the top surface of the base member 10 along the central axis of the top surface of the base member 10. In the embodiment of the present invention, the pin structure 12 has a characteristic shape in such a manner that individual pins are integrally connected to one another in series by a tie 13 formed on lower ends thereof at a predetermined height.

The pin structure 12 is configured so that an interval between the pins is gradually increased from the front to the rear of the base member 10. The interval between the pins is to copy after a dental structure of the human body. In detail, the interval between the pins constituting the pin structure 12 is set in view of the fact that, among the typical human teeth, the incisors forming the anterior arch have a small size and narrow arrangement of teeth, whereas the molars forming the posterior arch have a large size and wide arrangement of teeth. The difference between the intervals of the front and rear pins of the pin structure 12 prevents the die separated after the plaster molding work from being fitted into a wrong place, thereby making it easier for the die to find its own place.

When the dental model is placed, the pin structure 12 is fitted into the dental model, thereby serving to clamp the dental model. To this end, the pin structure 12 protrudes from the top surface of the base member 10 at a predetermined height.

Further, when the die or the partial dental model corresponding to the teeth to be treated after the dental model is molded and hardened is separated from the base member 10, the die should be easily separated from the pin structure 12 of the base member 10. To this end, each pin of the pin structure 12 has a double curved contour in such a manner that a taper part 12b, whose horizontal cross-sectional area is gradually increased from the top to the bottom, is formed on an upper portion thereof and that a linear part 12a, whose horizontal cross-sectional area is equal to that of the lowermost end of the taper part 12b, is formed under the taper part 12b to part of the entire height of the pin, i.e. to a predetermined height.

In other words, in the pin structure 12, a lower end of the pin, whose height accounts for the part of the entire height of the pin and which is in contact with the top surface of the base member 10, is made up of the linear part 12a whose horizontal cross-sectional area is the same throughout the height, and the other part extending from an upper end of the linear part 12a is made up of the taper part 12b whose horizontally cross-sectional area is gradually reduced in an upward direction.

This characteristic shape of the pin structure 12 facilitates demounting and mounting the die cut off from the entire dental model. The taper part 12b serves to facilitate demounting or separating the die from the base member. When the dental model or the die corresponding to the maxillary teeth of a patient is again fitted into the pin structure 12 after being separated from the base member 10, the linear part 12a serves to prevent the dental model or the die from being separated from the pin structure 12 without any resistance by self-weight of the dental model or the die during maxillomandibular mastication.

Further, the pin structure 12 is rounded at top edge and corners. Thus, when the dental model is separated from the base member 10, the pin structure 12 assists the dental model to be easily separated, and prevents the plaster adhered to the pin structure 12 from being torn off or cracked.

The pin structure 12 as described above has the shape of a truncated hexagonal pyramid, and the tie 13 is formed at the lower end of the pin structure 12 along a row of pins at a predetermined height. Thus, when the cut die is demounted from and mounted on the base member as needed during processing the dental model, the pin structure 12 prevents the die from undergoing arbitrary movement such as left-and-right movement, rotation, etc. due to a play between the pin structure and the die including a pin cap structure, so that precise dental laboratory work is possible.

In detail, the part of the dental model, i.e. the die, is cut off by sawing. In this case, a gap corresponding to the thickness of a saw occurs between the fixed dental model and the cut die due to the sawing. Since this gap is provided at either end of the die, a predetermined play takes place when the die is mounted on the base member.

However, due to both the truncated hexagonal pyramid shape of the pin structure and the tie 13 continuously formed at the lower end of the pin structure at a predetermined height, neither left-to-right movement nor torsion occurs when the cut die is placed on the base member.

Meanwhile, serial numbers 17 representing a sequence of the pins of the pin structure 12 are formed on the top surface of the base member 10 on one side of the pin structure 12. The serial numbers 17 are embossed on the top surface of the base member 10 so that they are formed in intaglio in a bottom surface of the dental model that is molded on the top surface of the base member. The serial numbers can be used as identification numbers for the die cut off from the dental model. Preferably, the serial numbers are formed as Arabic numbers so as to be able to enhance the easiness of identification.

In this manner, forming the serial numbers 17 in relief is intended to ensure convenient dental laboratory work of the die separated from the base member 10 by causing the serial numbers 17 to be formed in intaglio in the bottom surface of the dental model, and to overcome drawbacks that, when the serial numbers are embossed on the bottom surface of the dental model, the embossed serial numbers may be broken or damaged by easy contact or collision with another object and that, when the serial numbers are damaged, a dental technician has difficulty in identifying the serial numbers as well as positions of the cut numerous dies, and thus suffers from low workability.

A fixture piece 15 protrudes from the front surface of the base member 10 at a predetermined length. An insertion piece 25 is formed on a front bottom surface of the tray 20 coupled to the top surface of the base member 10, and is fitted around the fixture piece 15 so as to connect the tray 20 with the base member 10. This structure is allowed to effectively constrict movement of the tray 20.

Now, the tray 20 placed on the base member 20 will be described below in detail.

When the dental model is molded on the top surface of the base member 10 at a predetermined thickness, the tray 20 provides a mold for maintaining shape and dimensions of the dental model.

As shown in the figures, the inventive tray 20 is configured so that its entire shape is an arcuate shape (or a U shape) equal to that of the aforementioned base member 10, and is made up of a U-shaped or arcuate boundary wall 22a for supporting front and lateral surfaces of the dental model and a linear boundary wall 22b formed at a rear end of the arcuate boundary wall 22a in a linear shape, thereby providing a mold for molding the dental model.

The tray 20, in which the U-shaped or arcuate boundary wall 22a and the rear linear boundary wall 22b are coupled to provide one sealed mold, is provided with a through-hole 21 in an inner portion thereof and a pin cap structure 24 having a predetermined thickness. The pin cap structure 24 has fitting holes 24a continuously formed between the front arcuate boundary wall 22a and the rear linear boundary wall 22b in a central axial direction of the through-hole 21, so that the pins of the pin structure 12 formed on the top surface of the base member 10 can be fitted into the fitting holes 24a. The pin cap structure 24 is provided with tearaway notches 36 having a predetermined depth in top surfaces of opposite joints thereof. The joints of the pin cap structure 24 are connected with inner surfaces of the opposite boundary walls 22a and 22b, respectively. Thus, the boundary walls can be easily separated after the plaster is hardened.

Like the pins of the pin structure 12 formed on the base member 10, the fitting holes 24a formed in the pin cap structure 24 have the same structure as the human dental structure in such a manner that an interval therebetween is gradually increased from the front to the rear, and are configured so that their depths are slightly smaller than the heights of the pins of the pin structure 12. Thus, the upper ends of the pins of the pin structure 12 can be exposed to the outside of the pin cap structure 24 by a predetermined length after the pins of the pin structure 12 are fitted into the fitting holes 24a.

Further, the pin cap structure 24 is provided with ribs having a predetermined height along an edge thereof that is contacted with the top surface of the base member 10. Thereby, when the die is separated after the plaster is hardened, the ribs of the pin cap structure 24 allows the plaster adhered to the base member 10 to be easily released from the base member 10, and can prevent the plaster on the edge of the pin cap structure 24 from being damaged.

The edge of the pin cap structure 24 is provided with through-holes 37, one side of each of which is open. Hemispherical plaster injection ports 38, each of which has a larger diameter than each through-hole 37, are formed on the respective through-holes 37. When the plaster is placed in the tray 20 and is adhered to the top surface of the base member 10, the plaster runs into the through-holes 37 through the plaster injection ports 38, so that strong adhesive force is kept between the pin cap structure 24 and the dental model, and thus the pin cap structure 24 can be prevented from being separated from the dental model when the die is separated.

An outer surface of the boundary wall 22a of the tray 20 is tapered so as to have a slope inclined to the inside of the tray from the top to the bottom like the base member 10. Thus, the tapered outer surface of the boundary wall 22a of the tray 20 is generally harmonious with the tapered outer surface of the base member 10 when the tray 20 is placed on the top surface of the base member 10.

Further, the rear linear boundary wall 22b coupled to the front arcuate boundary wall 22a is configured to be attached to the front arcuate boundary wall 22a at a lower portion thereof and to be spaced apart from the front arcuate boundary wall 22a by a predetermined distance at an upper portion thereof, so that the upper portion thereof is located outside the lower portion thereof at an inclined angle so as to be able to cover a coefficient of expansion of the plaster molded and hardened in the tray 20.

The boundary walls 22a and 22b of the tray 20 are provided with L-shaped plaster anti-overflow flanges 30 at upper ends thereof, respectively. The plaster anti-overflow flanges 30 are bent in an outward direction of the tray 20, prevent the plaster for the dental model molded in the tray 20 from overflowing down, and facilitate separation of the boundary walls after the plaster is hardened.

The front arcuate boundary wall 22a of the tray 20 is provided with a plurality of tool insertion cages 28 in lower ends of both lateral surfaces thereof at predetermined intervals. The tool insertion cages 28 are recessed into the front arcuate boundary wall 22a by a predetermined depth so as to conveniently insert a tool between the top surface of the base member and a bottom surface of the plaster dental model when the plaster dental model is molded and then is separated.

The tool insertion cages 28 are intended to easily separate the die from the base member 10 when the dental model to be used for treatment is separated from the base member 10. When the process of separating the die, which is most difficult in the dental laboratory work, is performed, a pointed tool is inserted into the tool insertion cage 28 between the dental model and the top surface of the base member 10, and is pressed down on the basis of the principle of a lever, so that the dental model firmly adhered to the base member 10 is easily separated and thus the dental laboratory work is easily performed.

The front arcuate boundary wall 22a of the tray 20 is provided with hooks 27 at rear ends of both lateral surfaces thereof which are pushed onto an outer surface of the base member 10 and can prevent left and right movement of the tray 20 placed on the top surface of the base member 10. The hooks 27 extend downwardly from the rear ends of the front arcuate boundary wall 22a so as to be a little longer than the other portion of the front arcuate boundary wall 22a. The rear linear boundary wall 22b of the tray 20 is provided with a movement stopper 29 at a lower end thereof which is pushed onto a rear upper edge of the base member 10 so as to constrict the movement of the tray 20. The movement stopper 29 extends downwardly from the lower end of the rear linear boundary wall 22b to a predetermined height.

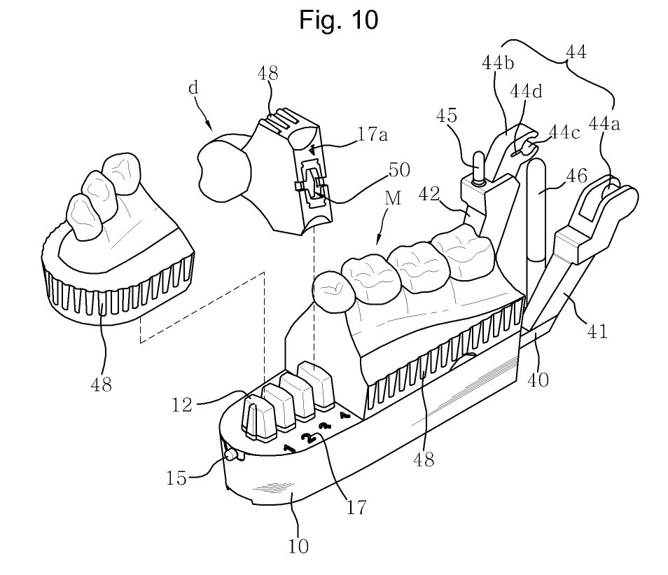

The front arcuate boundary wall 22a of the tray 20 is provided with round grooves 26 in an inner circumferential surface thereof at regular intervals. Thus, anti-slip protrusions 48 (FIG. 9) are embossed in an outer circumferential surface of the die separated after the dental model is molded, so that the die can be prevented from slipping off the hand of a worker while the worker is working with the die caught by the hand.

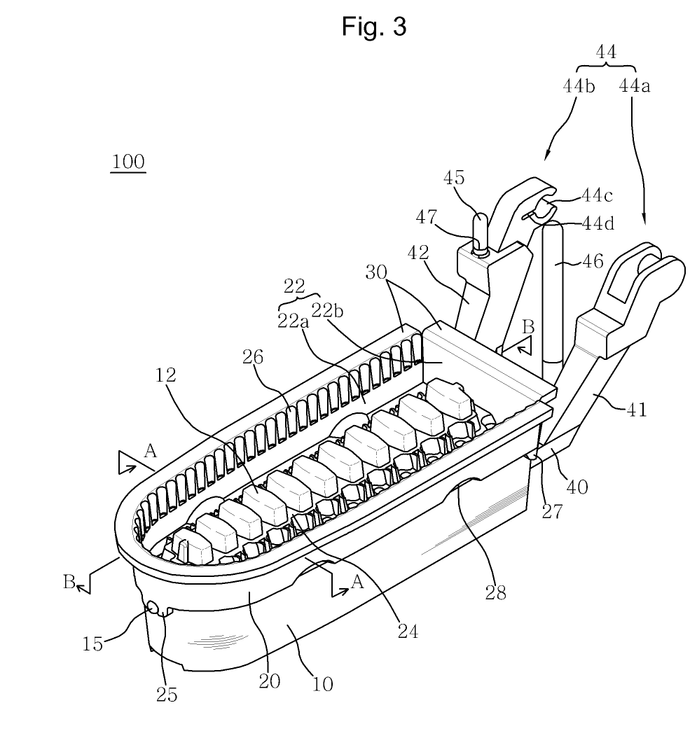

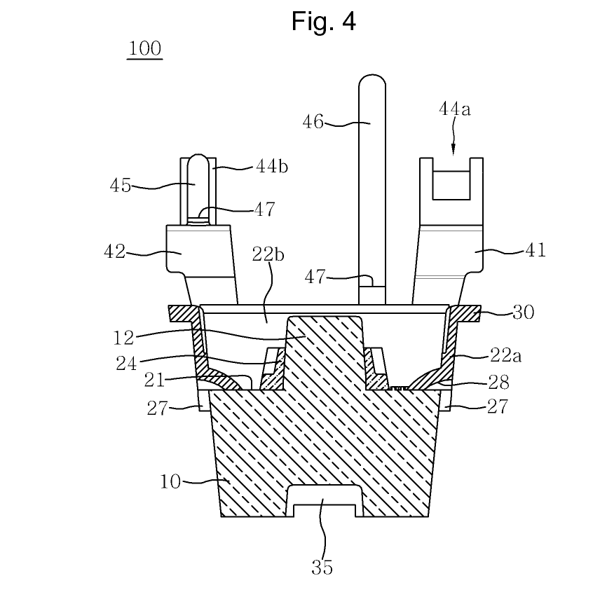

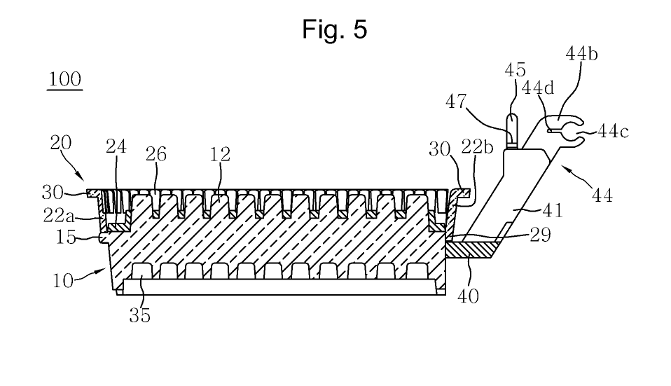

Meanwhile, FIG. 3 shows the coupled state in which the tray 20 is placed on the top surface of the base member 10, and FIGS. 4 and 5 are cross-sectional views taken along lines A-A and B-B of FIG. 3, respectively.

As shown in the figures, the tray 20 is placed on the top surface of the base member 10 by fitting the pins of the pin structure 12 of the base member 10 into the fitting holes 24 of the pin cap structure 24 of the tray 20. When the tray 20 is placed on the top surface of the base member 10, the pins of the pin structure 12 are partially exposed to the outside of the fitting holes 24a, so that the plaster injected into or placed in the tray 20 can come into direct contact with the upper ends of the pins of the pin structure 12.

Further, inner surfaces of the boundary walls 22a and 22b of the tray 20 are formed so as to slightly protrude from or be flush with an upper outer surface of the base member 10. Thus, an outer surface of the dental model molded in the tray 20 is formed so as to slightly protrude from or be flush with the upper outer surface of the base member 10. Thereby, the process of grinding the outer surface of the plaster dental model after the plaster is hardened and the boundary walls of the tray 20 are removed can be easily performed.

The base member 10 is provided with pressurization holes 35 in the bottom surface thereof into which the pins of the pin structure 12 formed on the top surface of the base member 10 can be fitted. After the tray 20 is placed on the top surface of the base member 10, the base member 10 is fitted into another tray 20 coupled to another base member 10 of another dental articulator so as to be able to pressurize the top surface of another pin cap structure 24 of the other tray 20. Thus, a bottom surface of the other pin cap structure 24 of the other tray 20 comes into close contact with the top surface of the base member 10, so that the base member 10 serves to a pressurization jig that can prevent a space from being formed between the bottom surface of the pin cap structure 24 and the top surface of the base member 10.

The pressurization holes 35 have the same number as the pins of the pin structure 12 formed on the top surface of the base member 10, and may have any depth as long as they can pressurize the upper portions of the pin structure 12 and the pin cap structure 24.

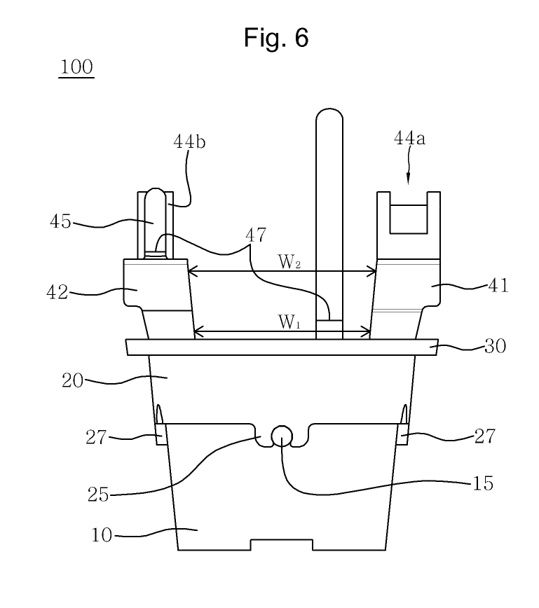

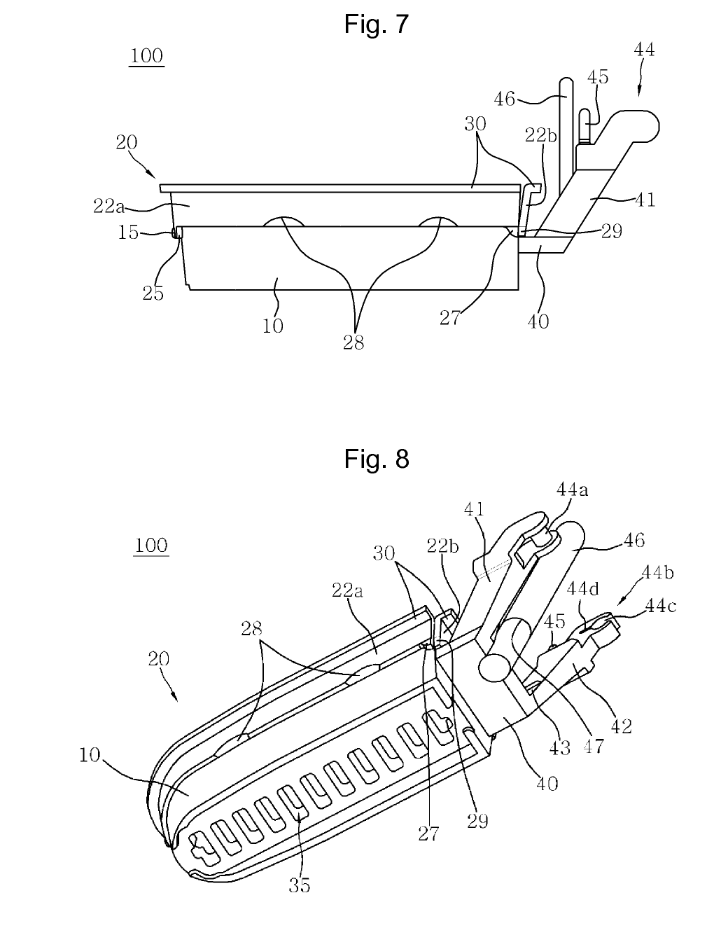

FIGS. 6 and 7 are front and side views showing the assembled state of the dental articulator according to the embodiment of the present invention, respectively.

As shown in the front view of FIG. 6, each of the tray 20 and the base member 10 has a tapered shape in such a manner that the outer surface thereof is inclined inwards from the top to the bottom, as described above. This configuration allows the rotor of a grinder to be prevented from coming into contact with the outer surface of the base member 10 to the utmost during grinding the dental model.

Further, the tray 20 coupled to the top surface of the base member 10 has the hooks 27, each of which protrudes from each rear end of the front arcuate boundary wall 22a by a predetermined height compared to the other front portion, so that it is possible to prevent the left and right movement of the tray 20 coupled to the base member 10.

The linear boundary wall 22b forming the rear of the tray 20 has the movement stopper 29 at the lower end thereof so as to surround the upper rear surface of the base member 10 at a predetermined height, so that it is possible to constrain forward and backward movement of the tray 20 along with the insertion piece 25 that is fitted around the fixture piece formed on the front upper end of the base member 10.

Meanwhile, the base member 10 has the flat joint plate 40 formed on the rear surface thereof at a predetermined size. A pair of support members 41 and 42 protrude upwardly from a top surface of the joint plate 40, and are spaced apart from each other by a predetermined distance. The opposite left and right support members 41 and 42 are designed so that an interval W₂ between upper portions thereof is wider than that W₁ between lower portions thereof, and so that the upper portions thereof is spaced apart from the base member 10 so as to be farther than the lower portions thereof in an inclined structure. Thereby, it is possible to efficiently support weight of the plaster dental model coupled to the top surface of the base member 10.

In this manner, the support members 41 and 42 are configured to be coupled to the base member 10 through the separate joint plate 40 so as to be spaced apart from the base member 10 by a predetermined distance, rather than be directly coupled to the rear end of the base member 10. Thereby, the process of molding the plaster dental model on the top surface of the base member 10 or the subsequent process of grinding the plaster dental model after the plaster is hardened can be conveniently performed.

Meanwhile, the support members 41 and 42 are provided with a connector pair 44 at upper ends thereof so as to protrude outwardly from bodies thereof. The connector pair 44 has a snap-on structure, which is made up of a male connector and a female connector at the upper ends of the opposite left and right support members 41 and 42.

In detail, the connector pair 44, which has the snap-on structure in which the male and female connectors make a pair, includes a pin-shaped pivot piece 44a and a recessed clamp piece 44b into which the pivot piece 44a is inserted and pivotably clamped, so as to enable a worker to easily handle a counter dental articulator when the counter dental articulator is connected to and disconnected from the dental articulator. The clamp piece 44b is provided with an opening 44c (FIG. 5) in the front thereof through which the pivot piece 44a can be inserted. The clamp piece 44b is additionally provided with a slit 44d in an inner circumference thereof so that the pivot piece 44a can be elastically clamped to the clamp piece 44b when the pivot piece 44a is connected to the clamp piece 44b.

The connector pair 44 formed at the upper ends of the support members 41 and 42 is provided with a cylindrical primary stopper 45 in the front thereof which has a predetermined height in an upward direction.

When the maxillary and mandibular articulators are coupled and pivot about the connector pair 44, the primary stopper 45 can prevent the maxillary and mandibular articulators, to each of which the dental model is coupled, from being folded beyond a predetermined angle.

That is, When the maxillary and mandibular articulators pivot about the connector pair 44 in order to check occlusal and masticatory relationships between the two articulators, the top surface of the primary stopper 45 formed on one of the support members 41 and 42 of the articulator comes into contact with a front portion of the connector pair of the counter dental articulator, so that it is possible to prevent the articulators from being excessively folded.

Further, the joint plate 40 is additionally provided with an auxiliary stopper 46 on the top surface thereof, and particularly at a position that deviates from the middle between the pair of support members 41 and 42. The auxiliary stopper 46 has a somewhat greater height than the support members 42 and 42. The auxiliary stopper 46 prevents excessive occlusion between the maxillary and mandibular articulators. Particularly, in the case of a free end type dental model in which no molars of the teeth of the patient are present, the auxiliary stopper 46 is configured to be able to prevent the excessive folding.

As shown in the figures, the top surfaces of the primary and auxiliary stoppers 45 and 46 are round. The front portion of the connector pair and the top surface of the joint plate 40 of the counter dental articulator, with which the primary and auxiliary stoppers 45 and 46 meet respectively, are flat. When a torsion angle should be given to the support members 41 and 42 according to the arrangement of teeth of a patient, the rounded top surfaces of the primary and auxiliary stoppers 45 and 46 smoothly slip on their contact surfaces, so that the articulator can be twisted.

Further, each of the primary and auxiliary stoppers 45 and 46 is provided with a removal notch 47 having a predetermined depth in the outer circumference of a lower end thereof. The removal notch 47 is intended to allow the primary and auxiliary stoppers 45 and 46 to be easily broken. In detail, when the maxillary and mandibular articulators should be folded beyond a typical occlusal angle due to the dental structure of a patient, they are no longer folded due to the primary and auxiliary stoppers 45 and 46. In this case, when a worker pushes aside the upper ends of the primary and auxiliary stoppers 45 and 46 using his/her own fingers, the primary and auxiliary stoppers 45 and 46 are easily broken at a position where the removal notch 47 is formed, so that the maxillary and mandibular articulators are folded beyond a predetermined angle so as to enable the worker to check the occlusal and masticatory relationships.

Although the primary stopper 45 is formed only on any one of the opposite support members 41 and 42, the same articulators can be coupled to each other for the maxillary and mandibular articulators. For example, when the maxillary articulator has the primary stopper located at the left support member, the mandibular articulator has the primary stopper located at the right support member. In this manner, the maxillary and mandibular articulators have a symmetrical structure. As a result, when the maxillary and mandibular articulators are coupled to each other, the primary stoppers are located at the opposite support members.

Further, the auxiliary stopper 46 is also formed so as to deviate from the middle between the opposite support members in one direction. Thereby, when the maxillary and mandibular articulators are coupled to each other, the auxiliary stopper formed on the maxillary articulator and the auxiliary stopper formed on the mandibular articulator are alternately formed, and are configured to come into contact with the joint plates of the counter dental articulators, respectively. The auxiliary stopper 46 is not integrally formed on the top surface of the joint plate 40, but is firmly fitted into a round recess, which is formed in a rear end of the joint plate 40, to a predetermined length.

The inventive dental articulator configured in this way is fabricated without distinguishing between the maxillary and mandibular articulators using one metal mold so as to be available for the maxilla and mandible at the same time, so that it is possible to save a cost of fabricating the metal mold which gives a burden to an enterprise at the beginning.

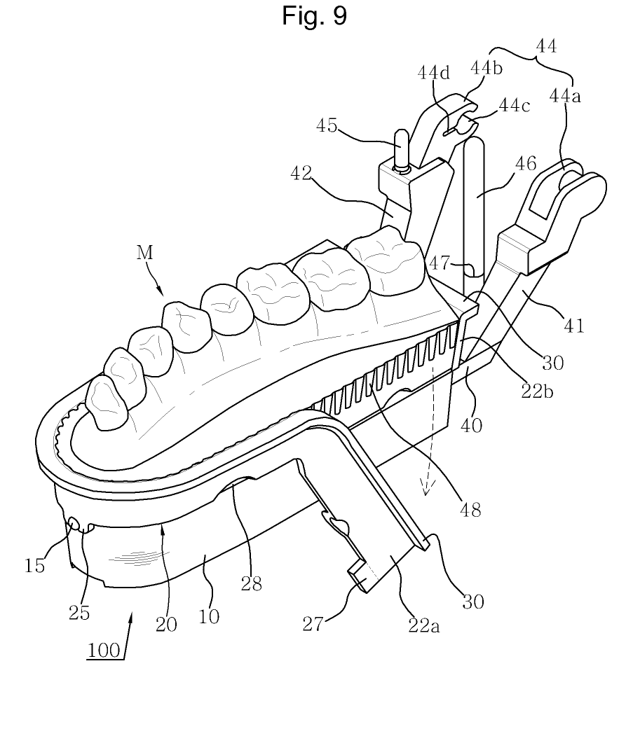

Meanwhile, FIG. 8 is a bottom-up perspective view showing the dental articulator according to the embodiment of the present invention.

As shown in the bottom-up perspective view of FIG. 8, the support members 41 and 42 are connected with the base member 10 by the joint plate 40. Since the support members 41 and 42 are configured so that the interval between the upper portions thereof is wider than that between the lower portions thereof. (W₂>W₁), they can more stably support the heavy plaster dental model when the dental model is placed. At least one reinforcement rib 43 is additionally formed on the lower end of each of the support members 41 and 42 coupled to the joint plate 40 so that it can reliably prevent swinging or rocking of the support members 41 and 42.

The connector pair 44 formed at the upper ends of the support members 41 and 42 is designed so that its regions connected with the support members 41 and 42 partially protrude outwardly beyond the bodies of the support members 41 and 42. This configuration can secure simple reliable operation of internal parts of a metal mold in an injection molding process, and simultaneously stable supporting and smooth pivoting of the connector pair 44 located at the upper ends of the support members 41 and 42.

Further, the joint plate 40 may be additionally provided with anti-slip protrusions (not shown) at outer corners of the bottom surface thereof. When a worker catches the base member 10 with his/her fingers, the anti-slip protrusions prevent the worker's fingers from slipping, and thus make it easy for the worker to apply external force as needed.

The pressurization holes 35, into which the pins of the pin structure 12 formed on the top surface of the base member 10 can be fitted to a predetermined depth with the pin cap structure 24 coupled to the pin structure 12, are formed in the bottom surface of the base member 10 in the same shape as the pins of the pin structure 12. After the tray 20 is placed on the top surface of the base member 10, the pressurization holes formed in the bottom surface of the base member of another dental articulator are fitted and pressed from the top surface of the base member to which the tray is coupled, so that the pin cap structure 24 can be brought into close contact with the top surface of the base member 10 without getting loose.

In detail, the dental articulator is typically formed of plastic. In the embodiment of the present invention, when the pin cap structure 12 is formed at a relatively thin thickness, it may undergo slight plastic deformation (e.g. twist) when formed at a predetermined length by injection molding. When this plastic deformation occurs, the pin cap structure 12 fails to come into close contact with the top surface of the base member 10, so that it slightly comes off the top surface of the base member 10. In the embodiment of the present invention, to prevent the pin cap structure 12 from coming off the top surface of the base member 10 due to the plastic deformation, the pressurization holes 35 are formed in the bottom surface of the base member 10 so that the base member 10 functions as a pressurization jig.

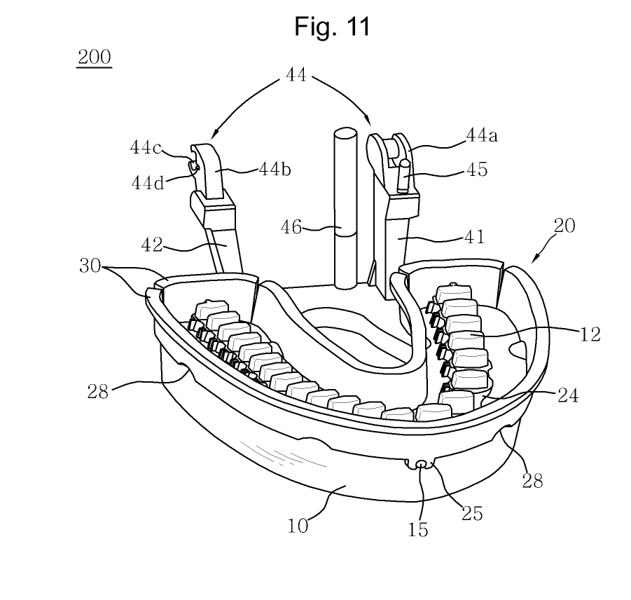

Meanwhile, FIG. 9 shows the state where the tray 20 is partially separated after the dental model M is hardened in the articulator according to the embodiment of the present invention. FIG. 10 shows the bottom surface of a partial dental model as a die “d” separated from the hardened dental model M by sawing.

In the state where the tray 20 is coupled to the base member 10, plaster for the dental model is placed and hardened in the tray 20. Then, the boundary walls 22 of the tray 20 are removed before the dental model corresponding to the teeth of a patient which need to be treated.

The L-shaped plaster anti-overflow flanges 30 are formed at the upper ends of the boundary walls 22 of the tray 20. When the plaster for the dental model is injected into the tray 20, the remainder of the plaster which is not injected into the tray remains on top surfaces of the plaster anti-overflow flanges 30. As such, the plaster does not overflow down to the outside of the base member. When the plaster anti-overflow flanges are pressed away in an outward direction of the tray 20, the boundary walls 22, which are in surface contact with the plaster, are pushed away in the outward direction of the tray 20, and thus are separated from the plaster for the dental model.

The U-shaped or arcuate front boundary wall 22a can be easily separated because it has no special connection with the base member excepting the contact with the plaster. Since the tearaway notches are formed in the joints of the pin cap structure buried in the plaster, the boundary walls are easily separated from the pin cap structure.

When the boundary walls 22 of the tray 20 are separated, dents are formed in outer lateral surfaces of the plaster dental model M, which is hardened on the top surface of the base member 10, so as to correspond to the tool insertion cages formed in the outer lateral surfaces of the tray 20. Thereby, when the separation of the tray 20 is followed by separation of the dental model M, the dents facilitate insertion of a tool. Further, a corrugated section is formed on the outer surface of the dental model by the grooves formed in the inner circumferential surface of the boundary wall of the tray, thereby preventing slippage when a worker catches the die separated from the base member.

As shown in FIG. 10, after the tray 20 is removed, the dental model is subjected to sawing, and then the dental model that is in contact with the top surfaces of the pin structure 12, the pin cap structure 24, and the base member 10 is separated.

Further, looking at a bottom surface of the die d that is the cut dental model, it can be found that a cavity 50 into which the pin structure 12 and the pin cap structure 24 are partially inserted is formed, and that a serial number mark 17a is formed in intaglio on one side of the cavity 50 by one of the serial numbers formed on the base member 10 in relief.

After necessary dental laboratory work is performed on the separated die, a worker can check the serial number mark formed in the bottom surface of the die, and then put the die into a designated site of the base member, so that the dental laboratory work is performed in a more convenient manner.

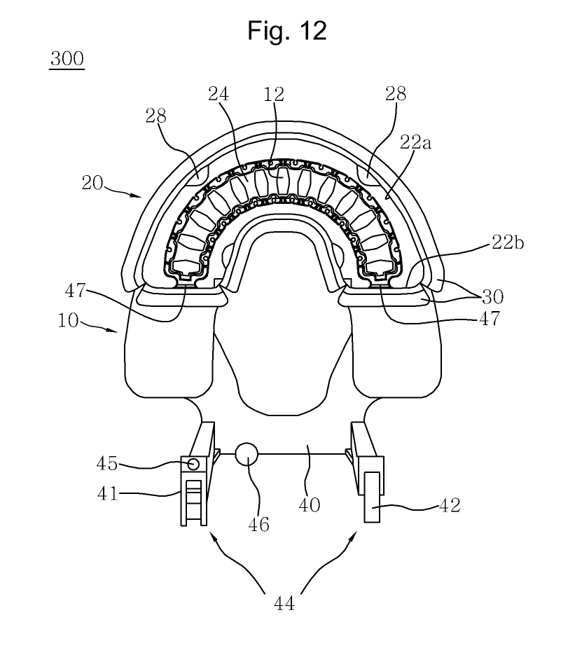

Meanwhile, FIGS. 11 and 12 show full-arch and anterior articulator 200 and 300 respectively, in which a full-arch tray and an anterior tray is coupled to the top surface of a base member, instead of the quadrant articulator. Configuration of each part of the tray and the base member is similar to the embodiment of the quadrant articulator.

Although an exemplary embodiment of the invention has been described for illustrative purposes, those skilled in the art will appreciate that various modifications, additions and substitutions are possible, without departing from the scope and spirit of the invention as disclosed in the accompanying claims.

According to the inventive dental articulator configured as described above, the dental articulator is used to fabricate the dental model of a patient at dental clinics and laboratories so as to be able to conveniently fabricate the dental model of the patient.

Particularly, when formed of plastic as a disposable dental articulator, the dental articulator has rigidity so as to make precise dental prosthetic work possible, so that it can service patients with more precise dental prosthetic appliances, compared to the related art.

1. A dental articulator comprising:
a base member on a top surface of which a dental model is molded;
a pair of support members that are formed at one end of the base member so as to have a predetermined height in an upward direction and a predetermined slope in an outward direction;
a pair of connectors that are formed at upper ends of the pair of support members so as to be coupled with a counter dental articulator;
a pin structure that is integrally formed with the base member at a predetermined height and that has a plurality of pins protruding upwardly from the top surface of the base member along a central axis of the top surface of the base member in a row at predetermined intervals; and
a tray that is coupled to the top surface of the base member, that includes a through-hole therein and a boundary wall formed along an edge thereof at a predetermined thickness and height, and that is geometrically similar to the base member.

2. The dental articulator according to claim 1, wherein:
the plurality of pins of the pin structure are continuously connected to one another at a predetermined height from lower ends thereof; and
the tray includes a pin cap structure having a plurality of fitting holes into which the pins of the pin structure are fitted, the fitting holes being continuously formed inside the boundary wall along a central axis of the tray at predetermined intervals.

3. The dental articulator according to claim 2, wherein:
the pin cap structure has a lower height than the pin structure, so that, when the pin cap structure is coupled to the pin structure, the pins of the pin structure are partially exposed out of the fitting holes of the pin cap structure; and
the pin cap structure includes through-holes that are formed in an edge thereof at predetermined intervals, and hemispherical plaster injection ports that are formed on the through-holes and have a larger diameter than the through-holes.

4. The dental articulator according to claim 3, wherein each of the pin structure and the pin cap structure is configured so that an upper portion thereof accounting for a part of the entire height thereof functions as a taper part whose horizontal cross-sectional area is gradually increased from the top to the bottom, and so that a lower portion thereof located under the taper part functions as a linear part whose horizontal cross-sectional area is equal to that of the lowermost end of the taper part.

5. The dental articulator according to claim 4, wherein the tray placed on the top surface of the base member is configured so that an inner surface of the boundary wall thereof is flush with an outer surface of the base member or slightly protrudes outwardly beyond the outer surface of the base member.

6. The dental articulator according to claim 3, wherein the base member has a fixture piece protruding from a front outer surface thereof at a predetermined length, and the tray has an insertion piece formed on a front bottom surface thereof so as to correspond to the fixture piece and fitted around the fixture piece.

7. The dental articulator according to claim 6, wherein:
the front arcuate (or U-shaped) boundary wall of the tray has hooks that extend from rear lower ends of both lateral surfaces thereof to a predetermined height and are pushed onto rear lateral surfaces of the base member so as to constrict left and right movement of the tray; and
the rear linear boundary wall of the tray has a movement stopper that extends from a lower end thereof to a predetermined height and is pushed onto a rear outer surface of the base member so as to constrict the movement of the tray.

8. The dental articulator according to claim 7, wherein:
each boundary wall of the tray has a plaster anti-overflow flange that is formed at an upper end thereof at a predetermined width and that is bent in an outward direction to prevent plaster from overflowing down; and
the front arcuate (or U-shaped) boundary wall of the tray includes a plurality of tool insertion cages in lower ends of both lateral surfaces thereof which are recessed inwards by a predetermined depth at predetermined intervals.

9. The dental articulator according to claim 8, wherein the front arcuate (or U-shaped) boundary wall of the tray includes round grooves formed in an inner circumferential surface thereof at regular intervals.

10. The dental articulator according to claim 9, wherein the base member includes pressurization holes formed in a bottom surface thereof so that, when another tray is coupled to another base member for another dental articulator, the base member is fitted onto another pin cap structure coupled to another pin structure and pressurizes the other pin cap structure.

11. The dental articulator according to claim 10, wherein the base member has serial numbers formed in relief on the top surface thereof on one side of the pin structure and representing a sequence of the pins of the pin structure.

12. The dental articulator according to claim 11, wherein the pin cap structure formed inside the tray has tearaway notches formed in top surfaces of opposite joints thereof which are connected with the inner surface of the boundary wall so as to be easily separated from the boundary wall.

13. The dental articulator according to claim 3, wherein:
the pair of support members are formed in parallel on a top surface of a flat joint plate, which is coupled to a rear surface of the base member at a predetermined size, so as to be inclined at a predetermined angle; and
the pair of support members are configured so that an interval therebetween is gradually increased from lower ends thereof coupled to the joint plate to upper ends thereof.

14. The dental articulator according to claim 13, wherein:
the connectors formed at the left and right upper ends of the support members are male and female connectors coupled in a snap-on structure;
the connectors include a pivot piece of a pin shape and a clamp piece of a recess shape into which the pivot piece is inserted, respectively; and
one of the pivot piece and the clamp piece includes a primary stopper formed in the front thereof in a cylindrical shape at a predetermined height, so that, when the dental articulator and the counter dental articulator for a maxilla and a mandible are coupled and occluded, the primary stopper prevents the maxillary and mandibular dental articulators from being folded beyond an optimum angle

15. The dental articulator according to claim 14, wherein the joint plate further includes an auxiliary stopper formed on one side of a rear end thereof at a height enough to come into contact with the surface of the joint plate of the counter dental articulator, so that, when the pair of dental articulators are coupled to each other by the connectors and are occluded along with the dental models, the auxiliary stopper prevents the maxillary and mandibular dental articulators from being folded beyond the optimum angle.

16. The dental articulator according to claim 15, wherein each of the primary and auxiliary stoppers is rounded at an upper end thereof, and includes a removal notch in an outer circumferential surface of a lower end thereof so as to be easily broken when pushed by a worker.

17. The dental articulator according to claim 16, wherein the connectors protrude outwardly from the upper ends of the respective support members beyond bodies of the support members, and the clamp piece of the female connector includes a slit formed in an inner circumference thereof so that the clamp piece can move elastically.

18. The dental articulator according to claim 12, wherein
the pair of support members are formed in parallel on a top surface of a flat joint plate, which is coupled to a rear surface of the base member at a predetermined size, so as to be inclined at a predetermined angle; and
the pair of support members are configured so that an interval therebetween is gradually increased from lower ends thereof coupled to the joint plate to upper ends thereof.

19. The dental articulator according to claim 18, wherein:
the connectors formed at the left and right upper ends of the support members are male and female connectors coupled in a snap-on structure;
the connectors include a pivot piece of a pin shape and a clamp piece of a recess shape into which the pivot piece is inserted, respectively; and
one of the pivot piece and the clamp piece includes a primary stopper formed in the front thereof in a cylindrical shape at a predetermined height, so that, when the dental articulator and the counter dental articulator for a maxilla and a mandible are coupled and occluded, the primary stopper prevents the maxillary and mandibular dental articulators from being folded beyond an optimum angle

20. The dental articulator according to claim 19, wherein the joint plate further includes an auxiliary stopper formed on one side of a rear end thereof at a height enough to come into contact with the surface of the joint plate of the counter dental articulator, so that, when the pair of dental articulators are coupled to each other by the connectors and are occluded along with the dental models, the auxiliary stopper prevents the maxillary and mandibular dental articulators from being folded beyond the optimum angle.

21. The dental articulator according to claim 20, wherein each of the primary and auxiliary stoppers is rounded at an upper end thereof, and includes a removal notch in an outer circumferential surface of a lower end thereof so as to be easily broken when pushed by a worker.

22. The dental articulator according to claim 21, wherein the connectors protrude outwardly from the upper ends of the respective support members beyond bodies of the support members, and the clamp piece of the female connector includes a slit formed in an inner circumference thereof so that the clamp piece can move elastically.

23. The dental articulator according to claim 4, wherein the base member has a fixture piece protruding from a front outer surface thereof at a predetermined length, and the tray has an insertion piece formed on a front bottom surface thereof so as to correspond to the fixture piece and fitted around the fixture piece.

24. The dental articulator according to claim 5, wherein the base member has a fixture piece protruding from a front outer surface thereof at a predetermined length, and the tray has an insertion piece formed on a front bottom surface thereof so as to correspond to the fixture piece and fitted around the fixture piece.

25. The dental articulator according to claim 4, wherein:
the pair of support members are formed in parallel on a top surface of a flat joint plate, which is coupled to a rear surface of the base member at a predetermined size, so as to be inclined at a predetermined angle; and
the pair of support members are configured so that an interval therebetween is gradually increased from lower ends thereof coupled to the joint plate to upper ends thereof.

26. The dental articulator according to claim 5, wherein:
the pair of support members are formed in parallel on a top surface of a flat joint plate, which is coupled to a rear surface of the base member at a predetermined size, so as to be inclined at a predetermined angle; and
the pair of support members are configured so that an interval therebetween is gradually increased from lower ends thereof coupled to the joint plate to upper ends thereof.
